(19) United States
(12) Patent Application Publication
(10) Pub. No.: US 2002/0005907 A1
(43) Pub. Date: Jan. 17, 2002

(54) Remote control unit with visual display device for cameras and video recorders

(76) Inventor: Brett G. Alten, Takoma Park, MD (US)

Correspondence Address: Brett G. Alten, Esq., 7004 Poplar Avenue, Takoma Park, MD, 20912, US

(21) Appl. No.: 09/842,101

(22) Filed: Apr. 25, 2001

Related U.S. Application Data
(60) Provisional application No. 60/199,592, filed on Apr. 25, 2000.

(51) Int. Cl. H04N 5/232

(52) U.S. Cl. 348/333.11; 348/64; 348/211; 348/333.07

(57) ABSTRACT

An image recording system that includes an image recorder and a remote control unit is provided. The image recorder includes an image storage device for recording one or more images, and a wireless transceiver that wirelessly transmits image information and receives control instructions. The remote control unit may be detachable from the recorder and include a wireless transceiver that wirelessly receives image information and transmits the control instructions, and an image display device that displays the image information. The image storage device can be for recording either still images or moving images, but may be capable of recording both. Methods for use with the image recording system are also provided.

### CROSS-REFERENCE TO RELATED APPLICATIONS

This claims priority under 35 U.S.C. 119(e)(1) to U.S. Provisional Patent Application No. 60/199,592, filed Apr. 25, 2000, which is hereby incorporated by reference in its entirety.

### FIELD OF THE INVENTION

This invention relates to image recording systems for capturing images remotely, and more particularly to image recording systems that include image recorders, such as cameras and video recorders, that can be remotely controlled.

### BACKGROUND OF THE INVENTION

Camera systems that allow a user to take self-portraits are known. For example, some cameras are provided with a timer that automatically causes the camera to take a photograph when the user is located remotely from the camera. Once the timer is set, the user has a fixed amount of time to move from the back of the camera to the front of the camera and to accurately position herself for the photograph. Unfortunately, the amount of time provided by the timer is not always sufficient to so position. Moreover, there is no way to confirm proper framing of the image or images being captured.

In order to provide the necessary amount of time, camera systems with remote control units were introduced. These remote control units can be purchased separately from or in combination with the camera and allow users to record images (e.g., take photographs) remotely without having to rush into position. Although these remote control units provide photographers with a sufficient amount of time, they do not provide a photographer with the ability to confirm that the photographs are properly framed.

In order to ensure proper framing, one camera has been provided with a special mirror that is positioned on the top of the camera to allow photographers to frame self-portraits. (See, “New to Konica Revio Family Three New Styles with Innovative Self-Portrait Mode,” <http://www.konica.com/products/ aps/cameras/revio.htm>. viewed and printed Apr. 22, 2000.) The mirror faces the front of the camera (in the same direction as the lens) and allows the photographer to get an approximate view of the image to be captured. Although the mirror provides some feedback, the camera-mounted mirror has a number of significant disadvantages. First, because the mirror is relatively small, a photographer may find it difficult to see, especially from long distances. Second, the mirror provides an inaccurate reproduction of the actual image being stored (e.g., photograph being taken). At least for these two reasons, the mirror does not ensure proper framing of self-portraits.

Some cameras include a preview function that lets a photographer preview an image before the image is stored (on film or in a digital recording medium) using a liquid crystal display device that is mounted on the back of the camera. (See, “World's First APS Preview Camera Lets Consumers Be Sure They Got the Shot, And Order Reprints On the Spot” <http://www.kodak.com/ country/US/en/corp/pressReleases/pr20000203-16.shtml>, viewed and printed Apr. 21, 2000.) Unfortunately, because the liquid crystal display is mounted on the back of the camera, it cannot be viewed during self-portrait mode.

It would therefore be desirable to provide an image recording system (e.g., a camera system) that provides a photographer the ability to record images from a position that is remote from the camera, but allows the photographer to preview the images before being stored.

It would also be desirable to provide an image recording system that allows a photographer to preview self-portraits without time constraints.

### SUMMARY OF THE INVENTION

It is therefore an object of this invention to provide methods and apparatus for capturing one or more images remotely.

It is also an object of this invention to provide an image recording system that provides a photographer the ability to record images from a position that is remote from the camera, but allows the photographer to preview the images remotely from the image recorder before the images are stored.

It is a further object of this invention to provide an image recording system that allows a photographer to preview self-portraits without time constraints.

In accordance with this invention, an image recording system is provided that includes an image recorder and a remote control unit. The image recorder includes an image storage device for recording one or more images, and a wireless transceiver that wirelessly transmits image information and receives control instructions. The remote control unit includes a wireless transceiver that wirelessly receives image information and transmits the control instructions, and an image display device that displays the image information. It will be appreciated that the image storage device can be for recording either still images or moving images, but may also be capable of recording both. Methods for use with the image recording system are also provided.

### BRIEF DESCRIPTION OF THE FIGURES

The above and other objects and advantages of the invention will be apparent upon consideration of the following detailed description, taken in conjunction with the accompanying drawings, in which like reference characters refer to like parts throughout, and in which:

FIG. 1 is a perspective view of an illustrative embodiment of an image recording system, including an image recorder and an attached remote control unit, in accordance with this invention.

FIG. 2 is a perspective view of the remote control unit shown in FIG. 1, shown unattached to the image recorder that is also shown in FIG. 1, in accordance with this invention.

FIG. 3A is a schematic of another illustrative embodiment of an image recorder in accordance with this invention.

FIG. 3B is a schematic of yet another illustrative embodiment of an image recorder in accordance with this invention.

FIG. 4 is a flow chart of steps of an illustrative method for remotely capturing one or more images with a remote control unit.

### DETAILED DESCRIPTION OF THE INVENTION

In order that the invention herein described may be fully understood, the following detailed description is set forth.

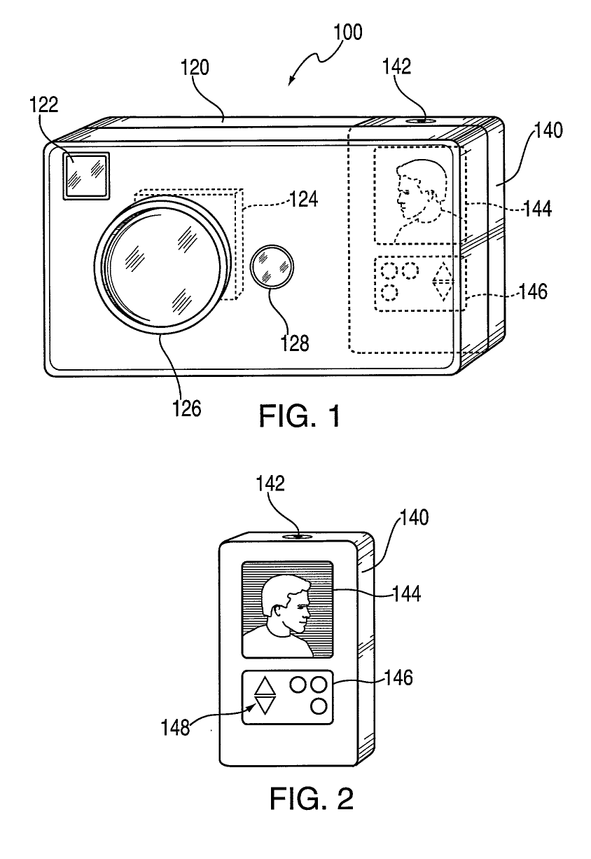

FIG. 1 shows image recording system 100, which includes image recorder 120 (e.g., a camera) and remote control unit 140 attached to recorder 120. Image recorder 120 includes: (1) image storage device 124 for storing one or more images and (2) wireless transceiver 122 for wirelessly transmitting image information and receiving control instructions. Remote control unit 140 includes: (1) wireless transceiver 142 for wirelessly receiving image information and for transmitting control instructions and (2) image display device 144 for displaying the image information.

Wireless transceivers 122 and 142 preferably communicate with each other via electromagnetic energy. It will also be appreciated that each of transceivers 122 and 142 may transmit and receive at different frequencies and/or may be divided into two completely separate units that performs different functions.

Image storage device 124 can be for recording either still images or moving images, but may also be capable of recording both. Storage device 124 can be, for example, photographic film and/or a charge-coupled device coupled to any conventional digital storage device, such as a magnetic storage device (e.g., a floppy disk), a magneto-optical storage device, or a semiconductor storage device, which is preferably non-volatile.

As used herein, image information is data that can be displayed on any display device that is positioned on a remote control unit and that may be in either digital or analog form. During use of system 100, the image information transmitted to remote control unit 140 can either be an accurate representation of the image to be stored by storage device 124, or one that roughly corresponds thereto. In an alternative embodiment, a complementary metal oxide semiconductor (“CMS”) chip can be used.

When only rough correspondence is required, two separate optical inputs 126 and 128 (e.g., lenses) can be used to independently receive light. First optical input 126 receives light corresponding to the image being captured (i.e., stored) and second optical input 128 receives light corresponding to the image information being transmitted to remote control unit 140. Because the light being received at the two inputs arrives along slightly different optical paths, the image being captured by storage device 124 and the image information transmitted to and displayed on remote control unit 140 are also somewhat different. Moreover, the magnification level of the two inputs may be different.

The correspondence between the image being captured by the storage device and the image information transmitted to and displayed on the remote control unit can be improved by processing the image information before the image information is displayed. For example, if the image recorder includes a zoom option (either optical or software driven), the zoom power can be used to “crop” the image information before it is displayed. It will also be appreciated that any conventional image processing routines can be applied to the image information to improve the quality of its display on the image display device. Also, conventional data compression techniques can be used to reduce the amount of data being transmitted to the remote control unit.

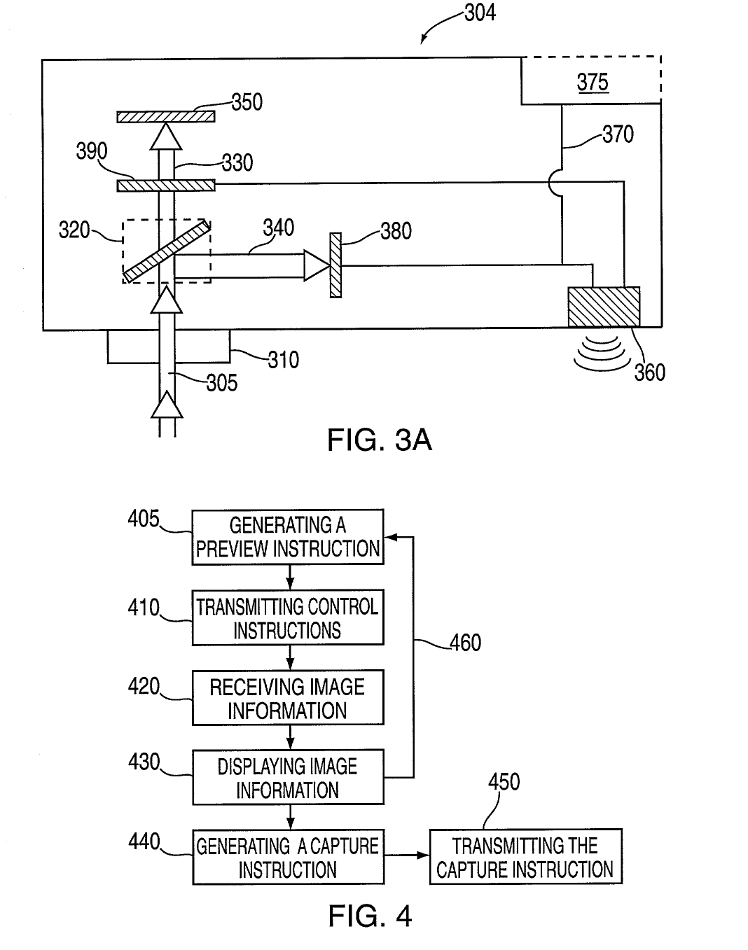

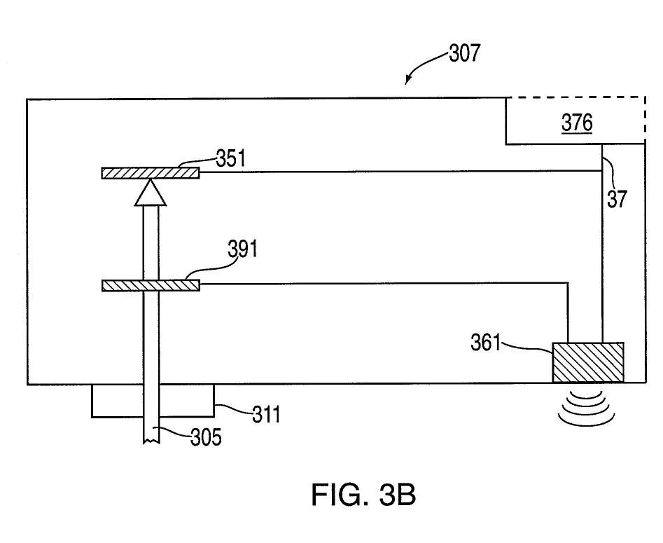

FIG. 3A shows a schematic of illustrative image recorder 304. As shown, a single optical input can be used in combination with a beam splitter so that the image being captured more accurately corresponds to the image information transmitted to the remote control unit. In this case, optical input 310 receives light corresponding to the image to be captured. Beam splitter 320 divides the light into at least first beam 330 and second beam 340. First beam 330 corresponds to the image being stored by and directed toward image storage device 350. Second beam 340 corresponds to the image information being transmitted to the remote control unit and is directed toward light detector 380. This transmission can be via transceiver 360 when the remote control is unattached to recorder 304 or via circuitry 370 when the remote control is attached in location 375.

Because both beams pass through the same optical input (e.g., lens) 310, the image information transmitted to detector 380 more accurately corresponds to the image being stored by image storage device 350. Light detector 380 is preferably a charge-coupled device, a CMS chip, or any other convenient light-detecting device for creating a data file or stream for transmission to the remote control. Shutter 390 can be controlled by the remote control unit and placed anywhere along the length of optical path 305 or 330.

A single optical input can also be used without the use of a beam splitter. For example, FIG. 3B shows a schematic of image recorder 307. In this case, optical input 311 receives light beam 306 corresponding to the image to be captured and the image information to be displayed on the image display device. In this embodiment, image storage device 351 is used to store images and to provide a signal for generation of the image information to be transmitted to and displayed on the image display device. Like image recorder 304, this transmission can be via transceiver 361 when the remote control is unattached to recorder 304 or via circuitry 371 when the remote control is attached in location 376. Shutter 391 can be controlled by the remote control unit and placed anywhere along the length of optical path 306. Because device 351 detects light for both storing images and generating image information, precise correspondence between them, including framing, is possible.

As shown in FIGS. 1 and 2, remote control unit 140 may be removably attached to image recorder 120. When attached, display device 144 preferably faces backward so that the photographer can use the preview function (see below) during normal use. Image display device 144 can be any portable display device, such as a liquid crystal display.

Remote control unit 140 also can include control panel 146. Control panel 140 includes at least one control, which, when activated, generates control instructions. As used herein, a control is any device that a user can use to generate instructions for controlling an image recorder. “Activation” can be achieved, for example, by detecting pressed buttons 148, receiving voice commands, or by any other conventional technique that can be adapted for use with the remote control unit.

Some of the controls that can be included are a preview control, which, when activated, generates a preview instruction, a capture control, which, when activated, generates a capture instruction, and (3) a zoom control, which, when used, generates zoom instructions for controlling a zoom lens mounted on image recorder 300. Receipt of a preview instruction causes image recorder transceiver 360 to send image information to a remote control unit, such as unit 140, for display on visual display device 144. Receipt of a capture instruction causes image recorder 144 to capture one image (in the case of a still image recorder) or a series of images (in the case of video recorder). Receipt of zoom instructions causes image recorder to adjust the power of zoom lens 310.

A method of capturing an image remotely using an image recording system described above is now provided. The method includes: in step 410, transmitting control instructions from the remote control transceiver to the image recorder transceiver; in step 420, receiving image information transmitted by the image recorder transceiver at the remote control transceiver; and in step 430, displaying the image information on the display device.

The transmission of control instructions, and the subsequent receipt and display of image information, can be initiated by activating one or more of the controls. Alternatively, the receipt and display of the image information can occur without activation of a control, such as when an image recorder's transceiver continuously or periodically transmits the information.

When a remote control unit includes a preview control and a capture control, activation can include, in step 405, generating a preview instruction in response to a user activating the preview control before transmitting the control instructions; and in step 440 (after displaying in step 430) generating a capture instruction in response to a user activating the capture control. Once a capture instruction is generated in step 440 and transmitted to the image recorder transceiver in step 450, an image can be captured by the image recorder. As indicated by line 460, a photographer can repeatedly generate preview instructions until the proper framing has been achieved. It will be appreciated that when a beamsplitter is used, as described above, the image being captured could be nearly identical to the image information being displayed on the display device.

A significant advantage of the present invention is that a photographer can repeatedly use the preview function before an image is captured. This provides the photographer (i.e., the person controlling the image recorder) the ability to reframe and preview the image repeatedly—without having to travel back and forth to the image recorder.

A complementary method is also provided for an image recorder according to this invention. The method includes receiving (by the image recorder transceiver) control instructions transmitted from the remote control transceiver, and transmitting (by the image recorder transceiver) the image information to the remote control transceiver for display of the image information on the display device. Receiving can include receiving a preview instruction in response to a user activating the preview control. In this case, transmitting would involve transmitting the image information to the remote control unit in response to receiving the preview instruction. The method then also can include receiving a capture instruction in response to a user activating the capture control.

In addition to the “on-demand” preview methods discussed above, it will be appreciated that image information can be transmitted to and displayed on the remote control unit continually. In this embodiment, control instructions need not be transmitted to the image recorder to initiate the transmission of image information to the remote control unit. Rather, the image recorder can continually transmit image information to the remote control unit, which continually displays and updates the information on its display device. In this embodiment, the remote control unit preferably also includes a capture control that allows the photographer to capture the image being currently or recently displayed on the image display device.

One skilled in the art will appreciate that the present invention can be practiced by other than the described embodiments, which are presented for purposes of illustration and not of limitation, and the present invention is limited only by the claims that follow.

I claim:

1. An image recording system, said system comprising:
an image recorder comprising:
an image storage device for recording an image, and
a wireless transceiver that wirelessly transmits image information and receives control instructions; and
a remote control unit comprising:
a wireless transceiver that wirelessly receives image information and transmits said control instructions, and
an image display device that displays said image information.

2. The system of claim 1 wherein said image storage device can store an image selected from a group consisting of a still image, a moving image, and a combination thereof.

3. The system of claim 1 wherein said image information roughly corresponds to said image.

4. The system of claim 3 wherein said image recorder further comprises:
a first optical input for receiving light corresponding to said image; and
a second optical input for receiving light corresponding to said image information.

5. The system of claim 1 wherein said image information accurately corresponds to said image.

6. The system of claim 5 wherein said image recorder further comprises:
a first optical input for receiving light corresponding to said image;
a beam splitter that divides said light into at least a first beam and a second beam, wherein said first beam is directed toward said image storage device, and wherein said first beam corresponds to said image; and
a light detector, wherein said second beam is directed toward said second light detector, and wherein said second beam corresponds to said image information.

7. The system of claim 6 wherein said image storage device is a silver-based film.

8. The system of claim 6 wherein said image storage device comprises a charge-coupled device coupled to a digital storage device or a CMOS chip.

9. The system of claim 6 wherein said light detector is selected from a group consisting of a charge-coupled device and a CMOS chip.

10. The system of claim 1 wherein said image storage device is selected from a group consisting of photographic film and a charge-coupled device coupled to a digital storage device.

11. The system of claim 1 wherein said wireless transceivers transmits and receives electromagnetic energy.

12. The system of claim 1 wherein said image display device is a liquid crystal display.

13. The system of claim 1 wherein said remote control unit removably attaches to said image recorder, and when said remote control unit is attached to said image recorder, said display device is on the back side of image recorder.

14. The system of claim 1 wherein said image recorder further comprises a shutter for controlling the amount of light permitted to enter said image recorder and to be stored in said image storage device, and wherein said remote control unit further comprises a control panel, said panel comprising at least one control, which when activated generates said control instructions.

15. The system of claim 14 wherein said at least one control comprises:
a preview control that when activated generates a preview instruction; and
a capture control that when activated generates a capture instruction.

16. The system of claim 14 wherein said image recorder further comprises a zoom lens, and wherein said at least one control further comprises a zoom control.

17. A method of capturing an image remotely using an image recording system, said system comprising: (1) an image recorder comprising an image storage device for recording images, and a wireless transceiver that wirelessly transmits image information and receives control instructions, and (2) a remote control unit comprising a wireless transceiver that wirelessly receives image information and transmits said control instructions, and an image display device that can display said image information, said method comprising:
transmitting control instructions from said remote control transceiver to said image recorder transceiver;
receiving said image information transmitted by said image recorder transceiver at said remote control transceiver; and
displaying said image information on said display device.

18. The method of claim 22 wherein said transmitting and receiving uses electromagnetic energy.

19. The method of claim 22 wherein said image recorder further comprises a shutter for controlling the amount of light permitted to enter said image recorder and to be stored in said image storage device, and wherein said remote control unit further comprises a control panel, said panel comprising at least one control, which when activated generates said control instructions, said method further comprising activating said at least one control.

20. The method of claim 24 wherein said at least one control comprises a preview control and a capture control, and wherein said activating comprises:
generating a preview instruction in response to a user activating said preview control before said transmitting; and
generating a capture instruction in response to a user activating said capture control after said displaying.

21. A method of capturing an image remotely using an image recording system, said system comprising: (1) an image recorder comprising an image storage device for recording images, and a wireless transceiver that wirelessly transmits image information and receives control instructions, and (2) a remote control unit comprising a wireless transceiver that wirelessly receives image information and transmits said control instructions, and an image display device that displays said image information, said method comprising:
receiving, by said image recorder transceiver, control instructions transmitted from said remote control transceiver; and
transmitting, by said image recorder transceiver, said image information to said remote control transceiver for display of said image information on said display device.

22. The method of claim 21 wherein said transmitting and receiving uses electromagnetic energy.

23. The method of claim 21 wherein said image recorder further comprises a shutter for controlling the amount of light permitted to enter said image recorder and to be stored in said image storage device, and wherein said remote control unit further comprises a control panel, said panel comprising at least one control, which when activated generates said control instructions, and wherein said at least one control comprises a preview control and a capture control, and wherein said receiving comprises:
receiving a preview instruction in response to a user activating said preview control, wherein said transmitting comprises transmitting said image information to said remote control unit in response to said receiving said preview instruction; and
receiving a capture instruction in response to a user activating said capture control.

24. An image recorder for use with a wireless transceiver that wirelessly receives image information and transmits control instructions, and an image display device that displays said image information, said image recorder comprising:
an image storage device for recording said image; and
a wireless transceiver that wirelessly transmits said image information and receives said control instructions.

25. The image recorder of claim 24 wherein said image storage device can store an image selected from a group consisting of a still image, a moving image, and a combination thereof.

26. The image recorder of claim 25 wherein said image storage device is primarily for storing still images.

27. The image recorder of claim 26 wherein said image information either roughly corresponds to said image or accurately corresponds to said image.

28. The image recorder of claim 27 wherein said image recorder further comprises:
a first optical input for receiving light corresponding to said image; and
a second optical input for receiving light corresponding to said image information.

29. The image recorder of claim 27 further comprising:
a first optical input for receiving light corresponding to said image;
a beam splitter that divides said light into at least a first beam and a second beam, wherein said first beam is directed toward said image storage device, and wherein said first beam corresponds to said image; and
a light detector, wherein said second beam is directed toward said light detector, and wherein said second beam corresponds to said image information.

30. The image recorder of claim 24 further comprising a shutter for controlling the amount of light permitted to enter said image recorder and to be stored with said image storage device.

31. A remote control unit for use with an image recorder comprising an image storage device for recording an image, and a wireless transceiver that wirelessly transmits image information and receives control instructions, said remote control unit comprising:
a wireless transceiver that wirelessly receives said image information and transmits said control instructions; and
an image display device that displays said image information.
